(19) United States
(12) Patent Application Publication
(10) Pub. No.: US 2008/0163292 A1
(43) Pub. Date: Jul. 3, 2008

(54) Methods, systems, and products for delivering media content

(76) Inventor: F. David Stallworth, Beaufort, SC (US)

Correspondence Address: SCOTT P. ZIMMERMAN, PLLC, PO BOX 3822, CARY, NC, 27519, US

(21) Appl. No.: 12/075,399

(22) Filed: Mar. 11, 2008

Related U.S. Application Data
(62) Division of application No. 09/884,131, filed on Jun. 20, 2001.

(51) Int. Cl. H04N 7/025

(52) U.S. Cl. 725/34

(57) ABSTRACT

Methods, systems and products are disclosed for delivering media products related to geographic terrain. Programs are produced that are related to a specific type of geographic terrain. The programs are aggregated into a program line-up and distributed as a channel. Products and services are advertised that are related to the specific type of geographic terrain on the channel.

### CROSS-REFERENCE TO RELATED APPLICATIONS

This application is a divisional of U.S. application Ser. No. 09/884,131, filed Jun. 20, 2001 and entitled “System and Method for Delivering Media Content” (Attorney Docket AT&T 00052), which is incorporated herein by reference in its entirety.

### BACKGROUND

1. Field of the Invention

The present invention relates generally to the production and distribution of media content and, more specifically, to a system and method for providing a national audience with media content produced within and related to a specific geographic terrain.

2. Background of the Invention

American consumers are well accustomed to paying for television services provided by cable television operators and satellite television operators. In comparison to free over-the-air television broadcasts, these services offer consumers enhanced reception and a larger selection of channels. With such appealing advantages, the subscriber base for these television services providers continues to expand. Industry analysts, such as Nielsen Media Research and Paul Kagan Associates, Inc., estimate that approximately 69 million American households subscribe to cable television. Solomon-Wolff Associates estimates that approximately 16 million households subscribe to direct-to-home satellite television. For purposes of the present invention, the providers of these television services are broadly referred to herein as media providers.

As the market continues to grow, further fueled by the deregulation of the cable television and telecommunications industries, the subscriber-based television services industry is becoming increasingly competitive. Media providers such as the cable television operators, telecommunication providers, and satellite television operators are all vying for the same subscribers. To win market share, each media provider strives to assemble the most appealing channel packages for the lowest price. In assembling these packages, media providers look to cable networks to provide popular, special interest channels. As used herein, cable network refers to a company that produces a program line-up for use as a channel of a cable television operator. Examples of cable networks include Nickelodeon, Cable News Network (CNN), and The Discovery Channel.

The media providers purchase cable network channels at wholesale prices, bundle them into packages, and sell them to subscribers at retail rates. The book, This Business of Television, Second Edition (1998), by Howard J. Blumenthal and Oliver B. Goodenough, explains the structure of this business in detail. For example, in a typical arrangement, a cable television operator pays each cable network a monthly fee in the range of 5 to 40 cents per subscriber per month. The operator groups the cable networks into packages, sometimes adding in local broadcast stations, and sells the packages to subscribers as “basic cable” for a monthly fee of approximately $30. This monthly fee can include markups of as much as 100 percent or more over the price the media provider pays the cable networks. The media providers derive additional profits from pay cable networks, sometimes assessing even higher markups over the monthly wholesale price.

Media providers measure the success of each cable network by the size of its audience. Larger audiences command more advertising dollars and, possibly, more subscriber fees (as is the case with pay cable networks such as Home Box Office (HBO)). Accordingly, each cable network has but one goal: to furnish the largest possible number of desirable viewers to the advertisers that provide the cable network with revenues. Ideally, these revenues cover the costs of producing media content (i.e., programs) as well as some margin of profit.

To attract subscribers, the media providers have long recognized the value of offering a diverse line-up of special interest, or “niche,” channels that cater to the varied interests of their customers. For example, well-known cable networks include Music Television (MTV), Home and Garden Television (HGTV), and the History Channel. The success of each of these special interest cable networks has proven that particular segments of an audience will seek out programming devoted to specific subject matter. Recognizing this fact, the advertisers, in turn, run commercials on networks that attract the audiences most likely to purchase their products.

This targeted programming strategy is not limited to television services. Just recently, subscription radio services, such as XM Satellite™ and Sirius™, have emerged to provide similar types of tailored programming channels to radio listeners. For instance, XM Satellite™ offers a Latin music channel, a classic rock channel, a sports channel, and a talk-radio channel.

Thus far, however, special interest or niche cable networks have been based on subject matter alone. In general, the subject matter dictates the types of programs that appear on the channel. For instance, a typical cable network might be based on subject matter such as music, home and garden, education, history, animals, and weather. The shows on these cable networks all generally relate in some way to the premise (i.e., subject matter) of the cable network.

On HGTV, for example, a viewer may watch shows such as “Bed & Bath Design,” “Gardening by the Yard,” and “Homes by Design,” all of which relate in some to the general subject matter of home and garden. Similarly, on the Animal Planet channel, a viewer may watch shows such as “Mother Nature,” “The Crocodile Hunter's Croc Files,” and “Pet Story,” which all relate to the general subject matter of animals.

The television programs for these special interest or niche cable networks are produced throughout the world. There are no limitations on the geographic scope of the programs. The only limit is on the subject matter. Thus, a home show on HGTV, such as “Homes Across America,” may feature homes of many different regions in the United States. Similarly, the shows on the Animal Planet channel travel to wherever the animals can be found. Thus, the production companies that create the shows necessarily travel throughout the world.

Although subject-matter-based cable networks can attract identifiable segments of an audience, advertisers are continually looking for new ways to attract particular consumers through a wide-based media platform. Ideally, from the cable network's perspective, the wide-based media platform would attract a larger pool of customers associated through some common thread, but not limited to any individual subject matter. This thread would also appeal to a group of advertisers seeking to reach that larger pool of customers. Attracting a larger audience and more advertisers would translate into increased revenues for the cable network and for the media providers that carry the cable network.

### SUMMARY OF THE INVENTION

The present invention is a system and method for delivering media content in which the media content is produced locally in a specific geographic terrain and distributed nationally for consumption by audiences inside and outside of that specific geographic terrain. Unlike the traditional special interest or niche cable networks, which aggregate programming based on particular subject matter and without regard to geographic terrain, the present invention uses local producers operating inside a specific geographic terrain to produce media content related to that geographic terrain. The geographically specific media content can be nationally distributed to appeal to audiences within and outside of the specific geographic terrain.

As used herein, a specific geographic terrain refers to an area having a distinguishable physical feature, such as water (i.e., coastal terrain), lack of water (i.e., desert terrain), or mountains (i.e., mountain terrain).

By providing programming relating to a specific geographic terrain, rather than a particular subject matter, the present invention creates an interesting and attractive entertainment resource with which audiences and advertisers can easily identify. The programming strikes a common chord among audience members having interest in the specific geographic terrain, but not necessarily the same subject matter within that geographic terrain. Indeed, the programming can include diverse subject matter relating to the specific geographic terrain, therefore providing a broader-based appeal than traditional subject matter television or cable networks. Advertisers having some connection to the geographic terrain would, in turn, value the programming's attractiveness to consumers interested in the geographic terrain and would, consequently, devote substantial resources to airing advertisements on the cable network providing the programming.

Thus, instead of limiting programming to subject matter such as news or sports, the present invention can appeal, for example, to audience members having interests related to a geographic terrain, such as coastal areas. In this specific implementation, the coastal area programming would include diverse subject matter relating to coastal areas, such as commercial fishing reports and coverage of sport fishing. As a significant benefit, the geographically specific programming would encompass whole industries, such as commercial fishing, sea shipping, and coastal tourism.

In a representative embodiment, the present invention includes a cable network that receives programming from local producers situated in a specific geographic terrain. For example, the specific geographic terrain could be coastal areas, mountain areas, or desert areas. The local producers generate programs relating to the specific geographic terrain and transmit the programs to the cable network. The cable network aggregates the programs into a full schedule of programming and transmits that programming to areas within and outside of the specific geographic terrain. The cable network effects this transmission preferably by delivering the programming to a media provider. The media provider offers the cable network as part of a channel package or, perhaps, offers the geographically specific cable network as a separate channel, charging a separate monthly fee. In either case, the wide appeal of the geographically specific cable network attracts both subscribers and advertisers.

### DESCRIPTION OF THE DRAWINGS

FIG. 1 is a schematic diagram of a system and method for delivering media content in which local producers located in coastal areas produce programs related to coastal areas, according to an embodiment of the present invention.

FIG. 2 is a schematic diagram of a system and method for delivering media content in which local producers located in mountain areas produce programs related to mountain areas, according to an embodiment of the present invention.

FIG. 3 is a schematic diagram of a system and method for delivering media content in which local producers located in desert areas produce programs related to desert areas, according to an embodiment of the present invention.

### DETAILED DESCRIPTION OF THE INVENTION

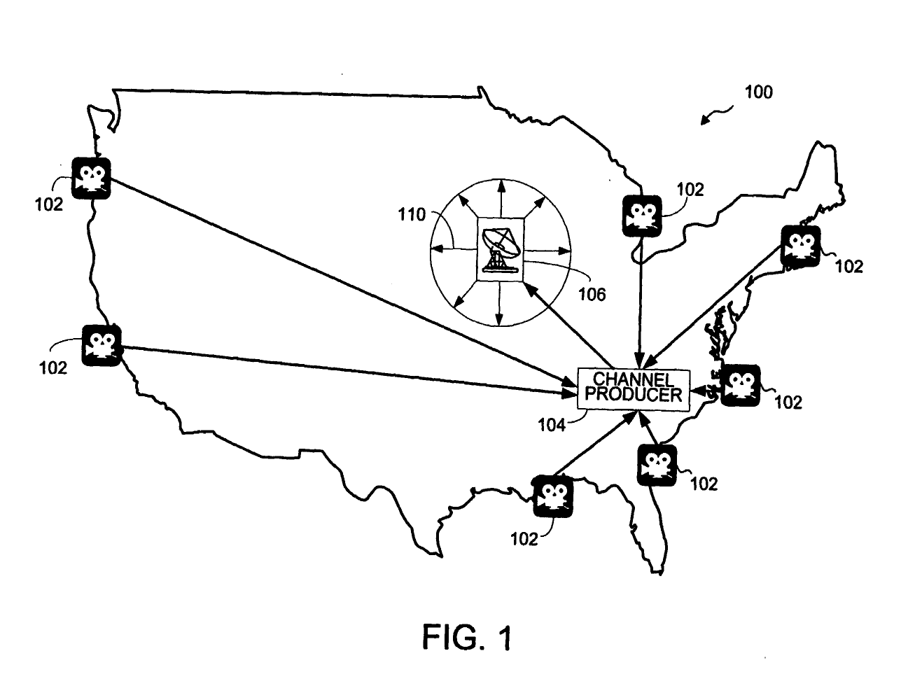

FIG. 1 illustrates a system 100 for producing and distributing geographically specific programming, according to an embodiment of the present invention. As shown, system 100 includes local producers 102, a channel producer 104 in communication with local producers 102, and a media provider 106 in communication with cable network 104. Local producers 102 are located on geographically specific terrain and produce television programs related to that terrain. Local producers 102 provide cable network 104 with the television programs.

Channel producer 104, in turn, aggregates the television programs into a full schedule of programming. Channel producer 104 transmits the programming within and outside of the specific geographic terrain. Channel producer 104 can perform this transmission directly or by delivering the programming to media provider 106. In a specific implementation of the present invention, channel producer 104 is a cable network that is bundled together with other cable networks and sold to subscribers through cable system operators. Alternately, channel producer 104 could be an over-the-air broadcast television network or a satellite network. As used herein, a satellite network refers to a company that produces a program line-up for use as a channel of a satellite television operator.

Media provider 106 distributes the television programs within and outside of the specific geographic terrain, as represented by the distribution arrows 110 pointing away from media provider 106 in FIG. 1. Preferably, media provider 106 delivers the programs nationally, well beyond the specific geographic terrain. Thus, the present invention can provide geographically specific programming for national consumption.

Media provider 106 could be, for example, a cable television operator, a satellite television operator, or, perhaps, a multiple system operator (MSO) that controls many cable television or satellite operators. AT&T Broadband, Time Warner Cable, and Comcast Cable Communications are examples of MSOs.

Media provider 106 could also be a television network (e.g., NBC, ABC, CBS, or UPN) with a group of local television station affiliates. In this case, the television network, being a single channel, would effectively function as channel producer 104 and media provider 106. In other words, the television network would aggregate the geographically specific programs received from local producers 102 into a program line-up, and would distribute the program line-up to a national audience through its network of local television station affiliates.

In a specific implementation of the present invention, as shown in FIG. 1, the geographically specific terrain is coastal terrain. For the purposes of this implementation, “coastal” may be defined broadly as any geographic area in which land meets a body of water. Thus, for example, local producers 102 could be located on seashores, shorelines, waterways, lakes, rivers, and bays. Correspondingly, local producers 102 located in these coastal areas would produce programs relating to the coastal areas.

The following table illustrates the types of geographically specific (coastal) programs that local producers 102 could provide:

| Program Title | Program Description |
|---|---|
| The Marine Report | News about fishing, gulf stream movements, |
| | shrimping, crabbing, offshore events, and |
| | ecology reports |
| The Edge of History | Historic events along the coast featuring |
| | coastal towns |
| The Edge of Real Estate | Tours of coastal properties that are for sale |
| The Edge of Seafood | Lessons on how to catch, clean, and cook |
| | seafood along the coast |

Although FIG. 1 illustrates the present invention in the context of a coastal cable network, it should be understood that the invention is not limited to this specific embodiment. Indeed, the present invention is broadly applicable to any media content that is limited to a specific geographic terrain, rather than simply to a subject matter.

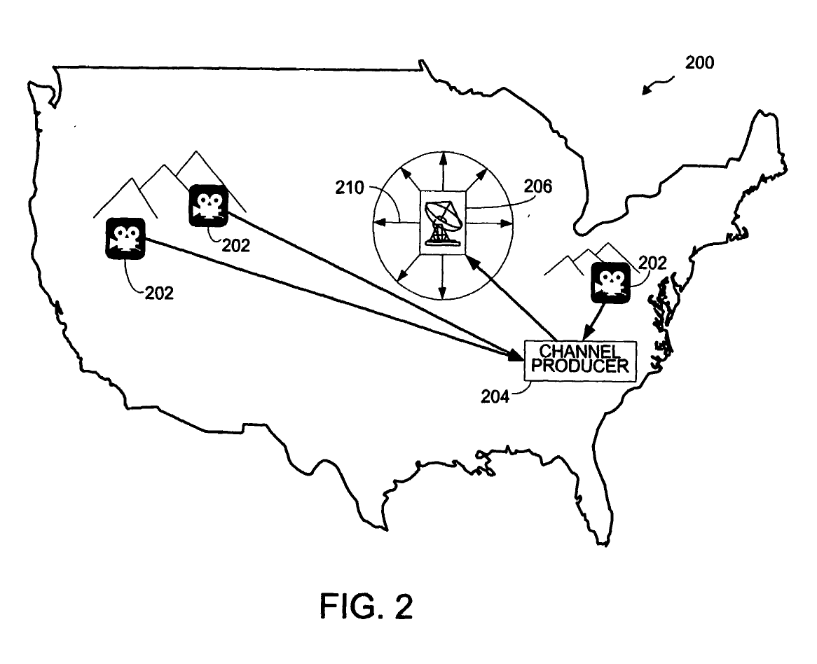

In another embodiment of the present invention, as shown in FIG. 2, a system 200 for producing and distributing geographically specific programming is associated with mountain terrain. In this embodiment, local producers 202 are in communication with a channel producer 204, which is in communication with a media provider 206. Local producers 202 are located in mountain terrain and produce programs related to the mountain terrain. Local producers 202 transmit the mountain terrain programs to channel producer 204.

Channel producer 204 assembles the mountain terrain programs into a programming line-up. Channel producer 204 transmits the mountain terrain programming line-up to media provider 206. Media provider 206 distributes the programming to areas inside and outside of the mountain terrain, as represented by distribution arrows 210. Preferably, media provider 206 delivers the programming to a national audience.

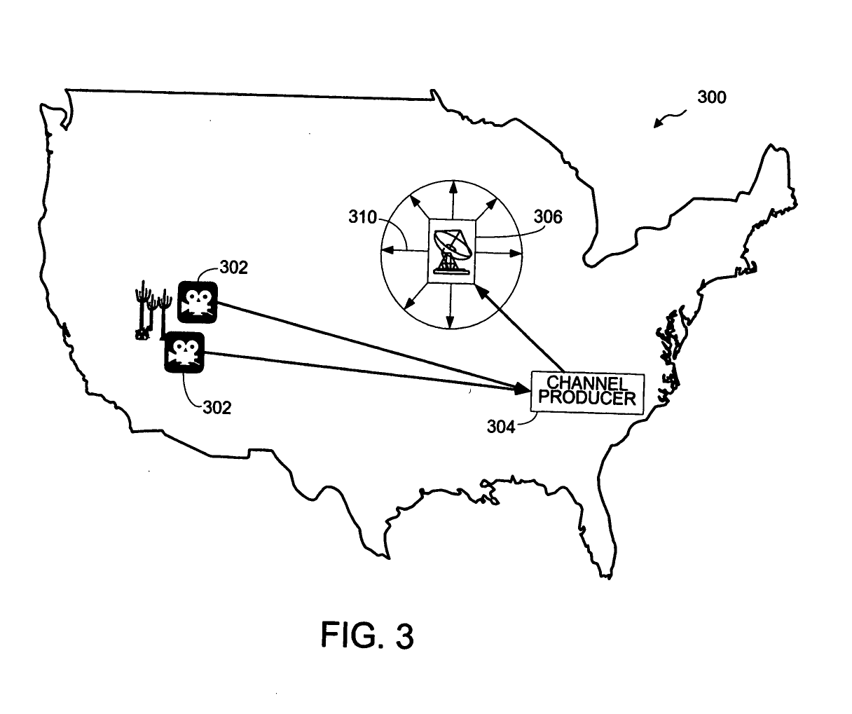

In another embodiment of the present invention, as shown in FIG. 3, a system 300 for producing and distributing geographically specific programming is associated with a desert terrain. In this embodiment, local producers 302 are in communication with a channel producer 304, which is in communication with a media provider 306. Local producers 302 are located in desert terrain and produce programs related to the desert terrain. Local producers 302 transmit the desert terrain programs to channel producer 304.

Channel producer 304 assembles the desert terrain programs into a program line-up. Channel producer 304 transmits the desert terrain program line-up to media provider 306. Media provider 306 distributes the programming to areas inside and outside of the desert terrain (as represented by distribution arrows 310), but preferably to a national audience.

Referring to FIGS. 1-3, in an alternate embodiment, channel producer 104 provides additional geographically specific programs to supplement those produced by local producers 102. These additional programs are also related to the specific geographic terrain (e.g., coastal, mountain, or desert) and are used to complete a full program line-up.

Distributing media programming focusing on a specific geographic terrain to a national audience carries significant benefits. The geographically specific programming possesses mass appeal for people having an association with the specific terrain. For example, in the case of coastal terrain, the programming strongly appeals to people working, living, vacationing, or retiring in the geographic terrain, or, more importantly, to people outside of the geographic terrain who are planning to do any of these activities.

As another benefit, the present invention creates a synergy between industries tied to the geographic terrain and the customers that do business there. The industries and customers look to a cable network (channel producer 104) of the present invention as a resource for business activities, information, and entertainment occurring in the geographic terrain. Companies (i.e., advertisers) and customers would use the cable network as a means of communication and a conduit for business. For example, in the case of a cable network devoted to coastal terrain, marine equipment companies could use the present invention to place their advertisements in front of the customers who are most likely to purchase their products.

The present invention is able to provide this benefit to companies and customers because the cable network programming is based on geographic terrain, rather than subject matter. This unique aspect of the cable network accommodates industries and advertisers that sell products and services related to a specific geographic terrain, but not necessarily tied to any one subject matter such as those typical of conventional special interest cable networks. For example, a boat company that sells leisure boats would have difficulty determining whether its target consumers watch a cable network based on home and garden (e.g., HGTV), sports (e.g., ESPN), or entertainment (e.g., E!). In contrast, the boat company would be fairly certain that a cable network devoted to coastal terrain would attract its target consumers.

Examples of other industries and advertisers that sell products and services related to a specific geographic terrain include the commercial fishing industry, the sport fishing industry, the water sport industry (e.g., surfing and water skiing), water resorts, retirement communities located in a specific geographic terrain (e.g., coastal or mountainous), and the coastal real estate industry.

In accordance with the benefits described above, an embodiment of the present invention provides a method for advertising that involves producing programs relating to a specific type of geographic terrain, aggregating the programs into a program line-up, televising the program line-up as a channel, and advertising products and services related to the specific type of geographic terrain on the channel.

In an alternate embodiment, the method for advertising involves in-program advertising, such as infomercials or product placements. In this embodiment, a local media producer produces a program related to a specific geographic terrain and integrates, into the program, advertising also related to the specific geographic terrain. The local media producer earns revenues from the in-program advertisers, which pays for the local media producer's costs in producing the program, as well as some measure of profit. The in-program advertisers would also pay a cable network (i.e., channel producer), either directly or through the local media producer, for the airing of the program and its integrated commercial content. As an example of this embodiment, for a channel devoted to coastal terrain, an in-program product placement could be an historical show about a coastal bed-and-breakfast, with contact information (e.g., a reservation telephone number) provided during the program. With reference to FIG. 1, in this alternate embodiment for generating revenue, local producers 102 pay channel producer 104 to air the program having in-program advertising.

The present invention also provides a system and method for generating revenue for a cable network and local media producer. According to this embodiment, local producers provide a cable network with programs related to a specific geographic terrain. In exchange for the programs, the cable network gives the local producer blocks of advertising space that the local producer can sell to generate revenue. This revenue covers the cost of producing the programs along with some margin of profit for the local producer. For the cable network, receiving programs in exchange for advertising space facilitates lower program development costs, allowing the cable network to keep more revenue derived from sales of other advertising spots run during the airing of the program.

With reference to FIG. 1, in this embodiment for generating revenue, local producers 102 provide channel producer 104 with programs produced within and related to coastal areas. Local producers 102 give channel producer 104 the programs for no charge. In exchange, channel producer 104 allots local producers 102 advertising time in the schedule of programming. Local producers 104 sell the advertising time to pay for the cost of producing the programs, including any profit.

In another embodiment of a system and method for generating revenue, a local media producer provides a channel producer with a block of programming related to a specific geographic terrain. As an example, the block programming could be for an entire evening (e.g., 6 PM-11 PM) or even an entire week. This arrangement frees the local media producer from the traditional constraints of half-hour or one hour time slots, and allows the local media producer to more easily blend advertising into the programming (either with commercial spots or in-program advertising). The content of the block programming would cover the community in which the local media producer is located, including, for example, the history of the community, tourist attractions in the community, and local events occurring in the community.

According to this embodiment, the block programming provided by one local media producer located in a community of the specific geographic terrain would appeal not only to the local residents of that community, but to potential tourists and retirees considering the community. The programming would also still be broadly appealing to viewers associated in some way with the specific geographic terrain.

In this embodiment, the local media producers would collect fees for advertisements featured in the block programming. The cable network airing the block programming would receive payments from either the local media producer or the advertisers. Alternatively, this embodiment could incorporate a revenue sharing model in which the local media producer and the cable network share revenues generated by the block programming, for example, in the form of percentages of revenues. This sharing model would encourage the local media producer to develop high quality programs that attract larger audiences to increase their share of the revenues.

Although this specification describes the present invention in the context of television, one of ordinary skill in the art would appreciate that the present invention is equally applicable to other media such as radio and global computer networks (e.g., the Internet). For this reason, and notwithstanding the particular benefits associated with using the present invention for over-the-air broadcast television, cable television, or satellite television, the system and method described herein should be considered broadly useful for any media provider wanting to attract subscribers and advertisers with targeted, interesting media content.

For example, in the case of radio, the media content could be audio content and channel producer 104 could be a radio station or network of radio stations. The radio station would receive programs created by local producers 102 located in a specific geographic terrain, would aggregate them into a program line-up, and would transmit the program line-up to areas within and outside of the specific geographic terrain. This transmission could be directly from the radio station, for example, in a regional or national broadcast using terrestrial transmitters or satellite transmitters. Alternately, the radio station could transmit the program line-up to media provider 106, which could be, for example, a multiple system operator that provides cable channels that run solely audio content, without video.

As another example, in the case of global computer networks such as the Internet, the media content could be video content, audio content, and data, and channel producer 104 could be a global computer network content provider, such as a web site. The web site would receive programs created by local producers 102 located in a specific geographic terrain, would aggregate them into a program line-up, and would transmit the program line-up to areas within and outside of the specific geographic terrain. In this embodiment, the web site could broadcast or distribute the program line-up via the global computer network directly to subscribers, essentially functioning as channel producer 104 and media provider 106.

In another embodiment of the present invention, the system and method provide interactivity between a channel producer and its audience, in addition to providing the production and distribution of geographically specific programming from the channel producer to the audience. Preferably, this interactivity occurs through a telephone network or a global computer network, such as the Internet. In this manner, a viewer watching the geographically specific programming can contact (e.g., by telephone, by electronic mail, or via the Internet) the channel producer to accomplish a variety of activities related to the specific geographic terrain.

According to this embodiment, the present invention includes selecting a specific type of geographic terrain that has a distinguishable physical feature, creating content related to the specific type of geographic terrain, aggregating the content into a program line-up, transmitting the program line-up to the viewers within and outside of the specific type of geographic terrain, and receiving communications from the viewers that initiate activities related to the specific type of geographic terrain.

For example, referring to FIG. 1, channel producer 104 could operate an Internet web site in addition to distributing geographically specific media content. Viewers receiving the media content could contact channel producer 104 via the Internet web site to perform any one or more of the following exemplary functions:
1) Order products that are advertised as part of the media content.
2) Order products related to a program being broadcast. For example, a viewer watching a historical program about a particular region of the specific geographic terrain could order a vacation package to that region.
3) Request and receive more detailed information about a program being aired.
4) Provide channel producer 104 with comments, questions, or suggestions regarding a program being aired. This viewer input could, in turn, be incorporated into the content of the program by, for example, displaying or announcing the particular viewer comments. Channel producer 104 could also respond to this viewer input, either through delivery of the media content (i.e., respond on air) or directly to each viewer through the Internet or by electronic mail.
5) Request more programming relating to a particular show or to a particular location in the specific geographic terrain.
6) Provide channel producer 104 with viewer feedback regarding a program being broadcast, which channel producer 104 can then compile into an online rating system.
7) Access streaming video that allows a viewer to see a particular segment of a show or obtain a more detailed view of an event or place.
8) Purchase products related to the geographically specific terrain at any time, independent of any program currently being aired. For example, on a coastal terrain channel, a viewer could always purchase marine products through the Internet web site of channel producer 104.

Thus, according to this embodiment, the system and method of the present invention includes two-way communication between the viewers and the channel producer. Delivery of the media content could be, as discussed above, through television, radio, or global computer networks. The interaction between the viewers and the channel producer could be through any network that links the viewers to the channel producer, including for example, a telephone network or the Internet. The delivery of the media content and the interaction between the viewers and the channel producer could also occur over the same network, such as the Internet.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

1. A method for advertising, comprising:
producing programs relating to a specific type of geographic terrain;
aggregating the programs into a program line-up;
distributing the program line-up as a channel; and
advertising products and services related to the specific type of geographic terrain on the channel.

2. The method according to claim 1, wherein the specific type of geographic terrain is one of a coastal terrain, a mountain terrain, and a desert terrain.

3. The method according to claim 1, wherein the products and services include one of a marine equipment company, a boat company, a commercial fishing company, a sport fishing service, a water sports equipment company, a water resort, a coastal retirement community, and a coastal real estate company.

4. The method according to claim 1, wherein the channel is one of an over-the-air network channel, and a satellite network channel.

5. The method according to claim 1, wherein the step of advertising comprises integrating an advertisement for the products and services into one of the programs.

6. The method according to claim 5, wherein the advertisement is one of an infomercial and a product placement.

7. A system for generating revenue for a channel producer and local media producers, comprising:
means for creating programs, at the local media producers, that relate to a specific type of geographic terrain;
means for producing a channel, at the channel producer, that televises the programs;
means for providing the channel producer with the programs of the local media producers at no cost to the channel producer;
means for providing the local media providers with portions of advertising time on the channel at no cost to the local media providers;
means for selling, at the local media providers, the portions of advertising time; and
means for selling, at the channel producer, other portions of advertising time on the channel to advertisers selling products related to the specific type of geographic terrain.

8. The system of claim 7, wherein the specific type of geographic terrain is one of a coastal terrain, a mountain terrain, and a desert terrain.

9. The system of claim 7, further comprising means for creating a block of programming related to a specific type of geographic terrain, and wherein the block of programming relates to the community in which a local media provider is located.

10. The system of claim 9, wherein the portions of advertising are one of commercial spots, infomercials, and product placements within the block of programming.

11. The system of claim 9, further comprising means for receiving at the channel producer a payment for televising the block of programming, wherein the payment is from the local media producer.

12. The system of claim 9, further comprising means for integrating an advertisement for the products and services into one of the programs.

13. A method for generating revenue for a channel producer and a local media producer, comprising:
creating a block of programming, at a local media producer, that relates to a specific type of geographic terrain;
producing a channel, at the channel producer, that televises only programs related to the specific type of geographic terrain;
televising the block of programming on the channel;
selling advertising that is televised with the block of programming;
receiving revenue for the advertising; and
sharing the revenue between the channel producer and the local media provider.

14. The method of claim 13, wherein the advertising is one of a commercial spot, an infomercial, and a product placement.

15. The method of claim 13, wherein the specific type of geographic terrain is one of a coastal terrain, a mountain terrain, and a desert terrain.

16. The method of claim 13, further comprising transmitting the channel within and outside of the specific type of geographic terrain.

17. The method of claim 16, wherein the media provider is one of a cable television operator, a satellite television operator, a multiple system operator, and a television network having a group of local television station affiliates.

18. The method of claim 13, further comprising integrating the advertising into the block of programming.

19. The method of claim 13, further comprising distributing the channel to a national audience.

20. The method of claim 13, further comprising:
providing free advertisement space in the block of programming in exchange for locally produced content, and
allotting free advertising space in the block of programming to a local producer of the locally produced content.
